(19) United States
(12) Patent Application Publication
(10) Pub. No.: US 2025/0125642 A1
(43) Pub. Date: Apr. 17, 2025

(54) CHARGING SYSTEM AND CHARGING METHOD OF BATTERY

(71) Applicant: TOYOTA JIDOSHA KABUSHIKI KAISHA, Toyota-shi (JP)

(72) Inventors: Masashi KOBAYASHI, Toyota-shi (JP); Jumpei Hosoi, Seto-shi (JP)

(73) Assignee: TOYOTA JIDOSHA KABUSHIKI KAISHA, Totota-shi (JP)

(21) Appl. No.: 18/889,951

(22) Filed: Sep. 19, 2024

(30) Foreign Application Priority Data
Oct. 13, 2023 (JP) 2023-177257

(51) Int. Cl. H02J 7/00; B60L 53/62; B60L 58/27; H01M 10/44; H01M 10/46; H01M 10/48; H01M 10/615; H01M 10/63; H01M 10/6571

(52) U.S. Cl. CPC H02J 7/0047; H01M 10/443; H01M 10/46; H01M 10/486; H01M 10/615; H01M 10/63; H01M 10/6571; B60L 53/62; B60L 58/27; H01M 2220/20

(57) ABSTRACT

A charging system includes a battery that is chargeable using an external power source, a heater raising the battery temperature, and a control device. The control device acquires the actual temperature of the battery and the output electric power of the external power source, sets a target temperature of the battery based on the output electric power, and drives the heater when the actual temperature is lower than the target temperature during charging of the battery using the external power source. The control device further compares the present value of the output electric power with the previous value of the output electric power during charging of the battery using an external power source, updates the target temperature based on the present value when the present value exceeds the previous value, and maintains the target temperature at the currently-standing value when the present value does not exceed the previous value.

### CROSS-REFERENCE TO RELATED APPLICATION

This application claims priority to Japanese Patent Application No. 2023-177257 filed on Oct. 13, 2023, incorporated herein by reference in its entirety.

### BACKGROUND

### 1. Technical Field

The present disclosure relates to a system and a method for charging a battery using an external power source.

### 2. Description of Related Art

Japanese Unexamined Patent Application Publication No. 2023-102958 (JP 2023-102958 A) discloses a system for a battery that is chargeable using an external power source (external charging). This conventional system performs driving control of a heater that raises temperature of the battery while the temperature of the battery during external charging is lower than a reference temperature. However, electric power from the battery during external charging is used for driving the heater. Accordingly, in the conventional system, electric power supplied from the external power source to the battery is compared with the smallest value of the electric power consumed by the heater during the driving control of the heater. When the electric power supplied from the external power source is smaller than the smallest value of the electric power consumption by the heater, the heater is intermittently driven.

In addition to JP 2023-102958 A, examples of documents describing the state of the art related to the present disclosure include Japanese Unexamined Patent Application Publication No. 2016-110957 (JP 2016-110957 A) and Japanese Unexamined Patent Application Publication No. 11-341698 (JP 11-341698 A).

### SUMMARY

There are some external power sources in which output electric power fluctuates in accordance with electric power consumption in households or various types of facilities. In the present disclosure, driving control of a heater during charging of a battery using such an external power source is considered. In this case, in order to shorten charging time, a target temperature of the battery is preferably changed during the driving control of the heater, in accordance with the output electric power. For example, when the output electric power is small, the target temperature is lowered, and when the output electric power is great, the target temperature is raised. Changing the target temperature in this way enables the electric power consumption by the heater to be suppressed while the output electric power is small, and the charging time can be shortened by raising the temperature of the battery while the output electric power is great.

However, when the target temperature is changed in accordance with the output electric power, actual temperature of the battery may change back and forth across the target temperature. When the actual temperature changes back and forth across the target temperature, stopping of driving of the heater and restarting of driving after the stopping is expected to repeatedly occur. As a result, an increase in a total number of times of stopping and restarting the driving accelerates deterioration of parts such as relays. Accordingly, when the target temperature is changed in accordance with the output electric power, improvement is desired from a perspective of suppressing trouble associated with the change from occurring.

An object of the present disclosure is to provide technology that is capable of reducing charging time, while suppressing occurrence of trouble associated with change in target temperature of a battery in accordance with output electric power of an external power source, when the battery is charged using the external power source.

A first aspect of the present disclosure is a charging system for a battery, and has the following features. The charging system includes a battery that is chargeable using an external power source, a heater for raising temperature of the battery, and a control device for controlling driving of the heater. The control device acquires an actual temperature of the battery and output electric power of the external power source, sets a target temperature of the battery based on the output electric power, and during charging of the battery using the external power source, drives the heater when the actual temperature is lower than the target temperature. The control device further compares a present value of the output electric power with a previous value of the output electric power, during charging of the battery using the external power source, and updates the target temperature based on the present value when the present value exceeds the previous value, and maintains the target temperature at a currently-standing value when the present value does not exceed the previous value.

A second aspect of the present disclosure is a charging method of a battery, and has the following features. The method includes a step of acquiring an actual temperature of a battery that is chargeable using an external power source, and output electric power of the external power source, a step of setting a target temperature of the battery based on the output electric power, a step of driving a heater for raising temperature of the battery, when the actual temperature is lower than the target temperature during charging of the battery using the external power source, a step of comparing a present value of the output electric power with a previous value of the output electric power, during charging of the battery using the external power source, and a step of updating the target temperature based on the present value when the present value exceeds the previous value, and maintaining the target temperature at a currently-standing value when the present value does not exceed the previous value.

According to the present disclosure, the present value of the output electric power of the external power source is compared with the previous value during charging of the battery using the external power source. When the present value exceeds the previous value, the target temperature of the battery is updated based on the present value. On the other hand, when the present value does not exceed the previous value, the target temperature is maintained at the currently-standing value. That is to say, the target temperature is updated only when the present value exceeds the previous value. Accordingly, the total number of times of stopping driving of the heater and restarting driving after stopping can be suppressed, as compared with when the target temperature is updated every time the output electric power fluctuates. Further, updating the target temperature based on the present value that exceeds the previous value enables the target temperature after the update to be set to a temperature that is higher than the target temperature before the update. Thus, the charging time can be shortened, as well.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration particularly related to a charging system according to an embodiment of the present disclosure;

FIG. 2 is a diagram illustrating an outline of drive control of a heater performed during charging of a battery using an external power source, and features of the embodiment;

FIG. 3 is a flowchart illustrating a flow of a process of driving control of a heater particularly related to the embodiment;

FIG. 4 is a diagram for explaining a second exemplary process of controlling the driving of the heater; and

FIG. 5 is a diagram for explaining a third processing example of the drive control of the heater.

### DETAILED DESCRIPTION OF EMBODIMENTS

Hereinafter, embodiments of the present disclosure will be described with reference to the drawings. However, the structures and the like described in the following embodiments are not necessarily essential to the present disclosure except for the case where they are particularly explicitly described or are clearly specified in principle.

### Battery Charging System

The battery charging system according to the embodiment is mounted on a vehicle, for example. The vehicle is, for example, a vehicle capable of performing plug-in charging by electric power supplied from an external power source provided outside the vehicle. Examples of such vehicles include plug-in hybrid electric vehicle (PHEV).

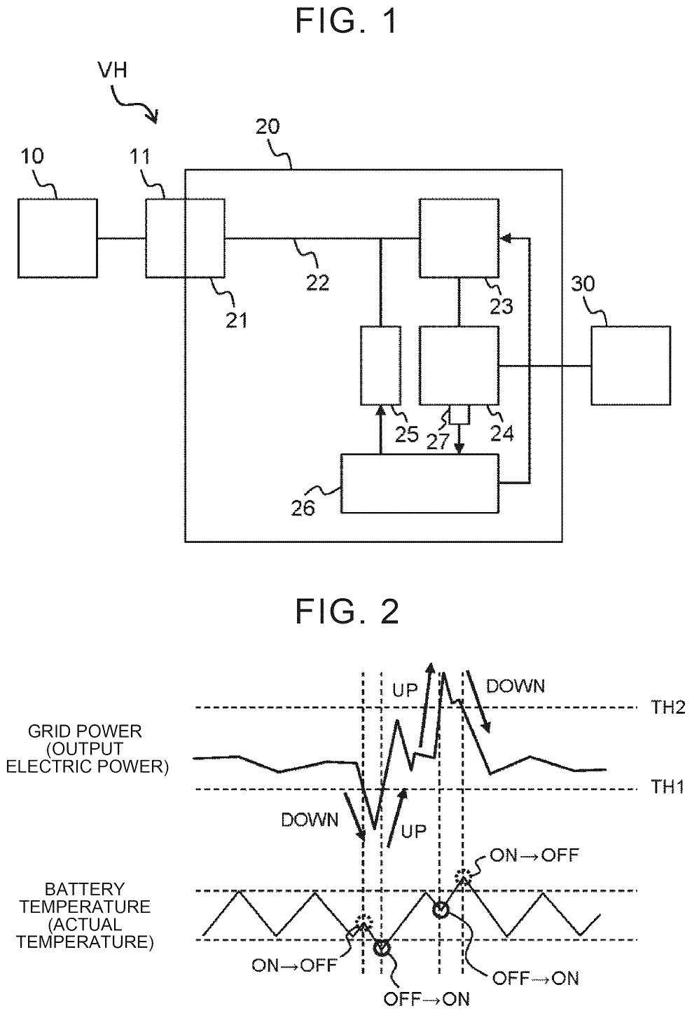

FIG. 1 is a diagram illustrating a configuration particularly related to a charging system according to an embodiment. FIG. 1 illustrates an external power source 10, a charging system 20, and a motor 30. The external power source 10 is, for example, a single-phase 100 V AC power supply or a single-phase 200 V AC power supply for home use. The external power source 10 includes a connector 11.

The charging system 20 is a configuration corresponding to the charging system of the battery according to the embodiment. The charging system 20 includes a charging lid 21, a power line 22, a step-up/step-down unit 23, a battery 24, a heater 25, a control device 26, and a temperature sensor 27.

The charging lid 21 is a part into which the connector 11 is inserted. The power line 22 connects the charging lid 21 and the step-up/down unit 23. The power line 22 also connects the charging lid 21 and the heater 25. The power line 22 supplies the electric power received from the external power source 10 through the connector 11 to the step-up/step-down unit 23 and the heater 25, respectively.

The step-up/step-down unit 23 is a device that charges the battery 24. For example, the step-up/step-down unit 23 includes, for example, a step-up/step-down converter (not shown) and various relays (not shown). The step-up/step-down converter boosts the electric power supplied from the external power source 10 based on a control signal from the control device 26. The various relays operate based on a control signal from the control device 26, and supply the electric power boosted by the step-up/step-down converter to the battery 24.

The battery 24 is a power storage device for driving the motor 30. The battery 24 is composed of a secondary battery such as a nickel metal hydride battery or a lithium-ion battery. For example, the battery 24 is formed by stacking a plurality of battery cells having a 1 V to 5 V degree.

The heater 25 is a device that heats the battery 24 by generating Joule heat by electric resistance by energizing, thereby raising the temperature of the battery 24. The temperature (actual temperature AT) of the heater 25 is measured by a temperature sensor 27 attached to the battery 24. The actual temperature AT measured by the temperature sensor 27 is outputted to the control device 26.

The control device 26 is a computer that performs various types of control in a vehicle on which the charging system 20 is mounted. The control device 26 includes computer hardware such as a processor and a memory, and operates in accordance with software such as an installed Operating System (OS) and an application program. Various controls executed by the control device 26 include drive control of the heater 25. The drive control of the heater 25 includes one that is performed during the plug-in charging of the battery 24 using the external power source 10 and one that is performed during the driving of the motor 30. The former drive control is performed from the viewpoint of charging efficiency, and the latter drive control is performed from the viewpoint of discharging efficiency. In the embodiment, attention is paid to the former drive control.

The motor 30 drives a vehicle on which the charging system 20 is mounted. The motor 30 is supplied with electric power from the battery 24. The motor 30 converts electric power supplied from the battery 24 into rotational energy to rotate the wheels. Note that a plurality of motors 30 may be provided.

### Heater Drive Control

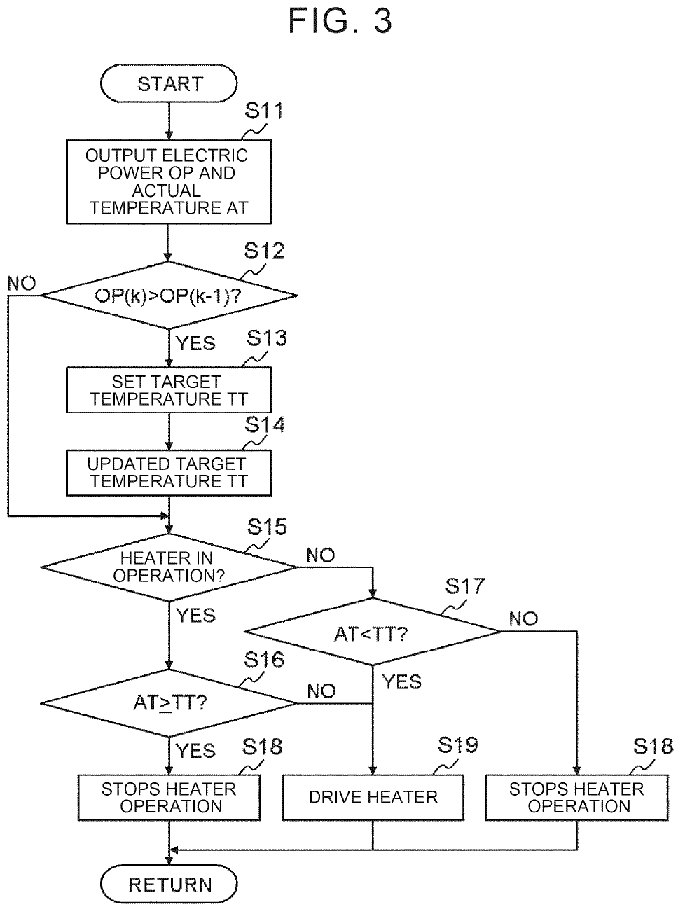

FIG. 2 is a diagram for explaining an outline of drive control of the heater 25 performed during plug-in charging of the battery 24 using the external power source 10 and features of the embodiment. The drive control of the heater 25 is performed when the actual temperature AT is lower than the target temperature TT of the battery 24.

In the embodiment, the target temperature TT is set based on the output electric power OP of the external power source 10 in order to shorten the charge time of the battery 24. The target temperature TT is set to, for example, a higher temperature as the output electric power OP increases. When the target temperature TT is set to a higher temperature, the actual temperature AT increases in a shorter time. Therefore, the charging time can be shortened with an increase in the charging efficiency. On the other hand, when the target temperature TT is set to a lower temperature, the electric power consumed by the heater can be suppressed.

In the embodiment shown in FIG. 2, the thresholds TH1 and TH2 for setting the target temperature of the battery are set based on the system power (the output electric power of the external power source). In this case, the target temperature is set by comparing the grid power with the thresholds TH1 and TH2. For example, when the grid power is smaller than the threshold TH1, the target temperature is set to the temperature TT1. When the grid power is larger than the threshold TH2, the target temperature is set to the temperature TT2 (TT2>TT1). When the grid power is between the thresholds TH1 and TH2, the target temperature is set to the temperature TT3 (TT2>TT3>TT1).

In the embodiment shown in FIG. 2, the grid power generally transitions between the thresholds TH1 and TH2. However, this embodiment includes a time period in which the system power becomes smaller than the threshold TH1 and a time period in which the system power becomes larger than the threshold TH2. In a time zone in which the grid power is smaller than the threshold TH1, the target temperature is changed from the temperature TT3 to the temperature TT1 (TT1<TT3). In a time zone in which the grid power is larger than the threshold TH2, the target temperature is changed from the temperature TT3 to the temperature TT2 (TT2>TT3).

When the target temperature is changed, the relationship between the target temperature and the actual temperature of the battery may be reversed before and after the change of the target temperature. When the magnitude relationship is reversed, there is a possibility that the execution of the drive control of the heater is affected. In the embodiment shown in FIG. 2, the drive of the heater is stopped (from ON to OFF) after the grid power drops below the threshold TH1 and after the grid power drops below the threshold TH2. Further, after the grid power increases and exceeds the threshold TH1 and after the grid power increases and exceeds the threshold TH2, the driving of the heater is resumed (ON from OFF).

Even when the target temperature is not changed, the stopping of the driving of the heater and the restarting of the driving after the stopping are repeated according to the magnitude relationship between the target temperature and the actual temperature of the battery. However, in the case where the target temperature is changed, it is expected that the stopping of the driving of the heater and the restarting of the driving after the stopping are repeated as compared with the case where the target temperature is not changed. As a result, an increase in a total number of times of stopping and restarting the driving accelerates deterioration of parts such as relays.

Therefore, in the embodiment, the target temperature TT is updated only when the output electric power OP becomes large during the plug-in charge of the battery 24 using the external power source 10. In the above-described embodiment, the target temperature TT is set to a higher temperature as the output electric power OP increases. Therefore, updating the target temperature TT only when the output electric power OP becomes large means allowing updating of the target temperature TT only to change to a higher temperature. Therefore, the total number of times of stopping and restarting the driving can be suppressed as compared with the case where the target temperature TT is changed to the high temperature and the target temperature TT is changed to the low temperature. In addition, the charge time can be shortened by changing the target temperature TT to a higher temperature.

### Example of Processing

FIG. 3 is a flowchart illustrating a flow of a process of driving control of the heater 25 particularly related to the embodiment. The routine shown in FIG. 3 is repeatedly executed by the processor of the control device 26, for example, while the connector 11 is inserted into the charging lid 21 (i.e., during a plug-in).

In the routine shown in FIG. 3, first, the output electric power OP and the actual temperature AT are acquired (S11). The output electric power OP may be acquired from the external power source 10 or may be acquired from the step-up/step-down unit 23. The actual temperature AT is acquired from the temperature sensor 27.

Following S11 process, it is determined whether or not the present value OP (k) of the output electric power OP exceeds the previous value OP (k-1) (S12). The present value OP (k) is the most recent value of the output electric power OP obtained in S11 process. The previous value OP (k-1) is, for example, a previous value of the output electric power OP obtained in the process of S11 of the previous routine. In another embodiment, the previous value OP (k-1) is an output electric power OP obtained at a time earlier than the acquisition time of the present value OP (k) by a predetermined time in the history of the output electric power OP.

If S12 determination is positive, S13 and S14 are processed. Otherwise, S13 and S14 processes are skipped and S15 processes are performed. In S12 process, the present value OP (k) and the previous value (k-1) may be simply compared. Further, in order to detect a significant increase in the output electric power OP while allowing some variation in the output electric power OP, a predetermined margin may be added to the previous value (k-1) and then compared to the present value (k). In addition, the previous value (k-1) does not exist immediately after the plug-in. Therefore, S13 and S14 are exceptionally processed.

In S13 process, the target temperature TT is set. The target temperature TT is set to a higher temperature as the output electric power OP increases. In S14 process, the target temperature TT is updated using the most recent target temperature TT set in S13 process. If S13 and S14 processes are not performed, the target temperature TT is not updated. In this case, the currently-standing value of the target temperature TT is maintained. The currently-standing value of the target temperature TT is set in the process of S13 before the previous routine.

In S15 process, it is determined whether or not the heater 25 is being driven. If S15 is positive, S16 process is performed. Otherwise, S17 process is performed.

In S16 and S17 processes, the target temperature TT and the actual temperature AT are compared, respectively. The target temperature TT is the present value of the target temperature TT. The actual temperature AT is the most recent value of the actual temperature AT obtained in S11 process. In S16 process, it is determined whether or not the actual temperature AT is equal to or higher than the target temperature TT. In S17 process, it is determined whether or not the actual temperature AT is less than the target temperature TT. When the determination result of S16 is positive and the determination result of S17 is negative, the driving of the heater 25 is stopped (S18). When the determination result of S16 is negative and the determination result of S17 is positive, the heater 25 is driven (S19).

### Another Example of Processing

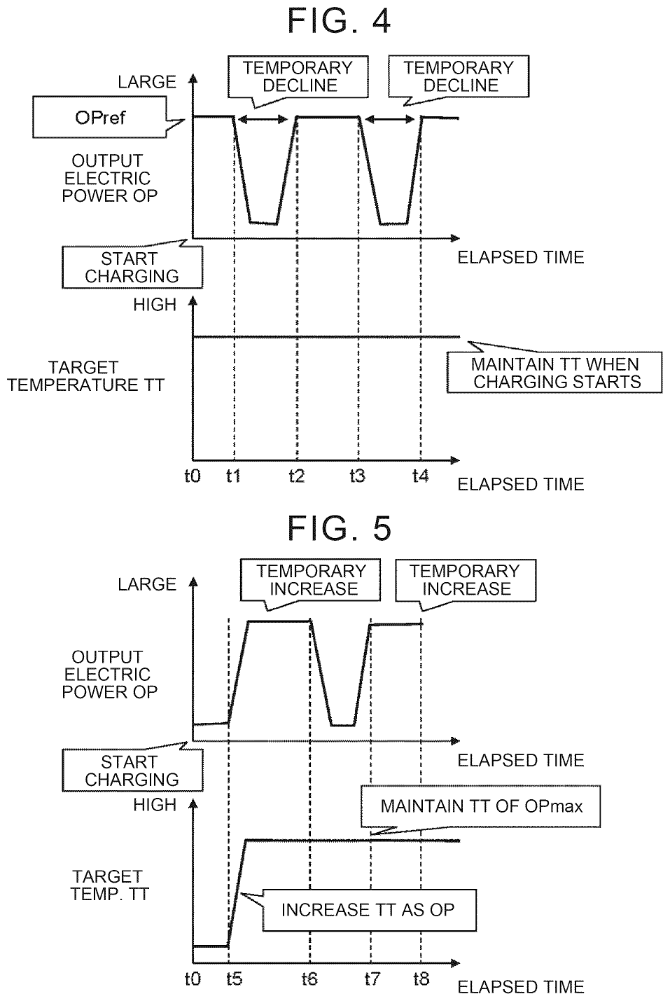

In the embodiment, a part of the processing example (the first processing example) described with reference to FIG. 3 may be modified. FIG. 4 is a diagram for explaining a second processing example of the drive control of the heater. FIG. 5 is a diagram for explaining a third processing example of the drive control of the heater.

In the second process illustrated in FIG. 4, the output electric power OP at the time of starting the charge (time t0) is set to the reference OPref. During the plug-in charge, it is determined whether or not the present value OP (k) exceeds the reference value OPref. This determination is performed, for example, following the process of S11 of FIG. 3. Then, when it is determined that the present value OP (k) exceeds the reference value OPref, S12 process is performed, and when it is determined that the present value OP (k) does not exceed the reference value OPref, S15 process of FIG. 3 is performed.

If it is determined whether or not the present value OP (k) exceeds the reference value OPref following the process of S11 of FIG. 3, the following benefits are expected. That is, when the output electric power OP at the beginning of charging is large, it is assumed that the output electric power OP temporarily decreases (time t1 or t3 in FIG. 4) during plug-in charging. However, the determination is performed in a time period in which the output electric power OP is increased following the temporary decrease (for example, a time period t2 the time in FIG. 4 or a time period prior to t4), so that the process of S12 to S14 in FIG. 3 can be skipped.

In the embodiment in which the target temperature TT is set to a higher temperature as the output electric power OP increases, the target temperature TT higher than the currently-standing value is not set when the output electric power OP increases following a temporary decrease. In this regard, by performing the above determination, it is possible to maintain the currently-standing value of the target temperature TT by avoiding the setting and updating of the target temperature TT lower than the currently-standing value (that is, the process of S13 and S14 in FIG. 3).

In the third process illustrated in FIG. 5, the maximal OPmax of the output electric power OP from the beginning of the charge to the present is recorded. Then, during the plug-in charge, it is determined whether or not the present value OP (k) exceeds the maximal value OPmax. This determination is performed, for example, following the process of S11 of FIG. 3. Then, when it is determined that the present value OP (k) exceeds the maximum value OPmax, S12 process is performed, and when it is determined that the present value OP (k) does not exceed the maximum value OPmax, S15 process of FIG. 3 is performed.

If it is determined whether or not the present value OP (k) exceeds the maximal value OPmax following the process of S11 of FIG. 3, the following benefits are expected. That is, when the output electric power OP at the time of starting charging is small, it is assumed that the output electric power OP temporarily increases (time t5 to time t6 and time t7 to time t8 in FIG. 5) during plug-in charging. Therefore, when the determination is performed in the time period in which the output electric power OP is increased, the target temperature TT higher than the currently-standing value can be set and updated (that is, S13 and S14 process in FIG. 3).

In the embodiment in which the target temperature TT is set to a higher temperature as the output electric power OP increases, a higher target temperature TT than the currently-standing value is not set unless the output electric power OP exceeds the maximum value OPmax from the beginning of charging to the present. In this regard, since the above determination is performed, it is possible to reliably set and update the target temperature TT based on the most recent maximum value OPmax when the output electric power OP exceeds the maximum value OPmax from the start of charging to the present. Otherwise, the maximum-value OPmax from the start-of-charge to the present can be maintained at the target temperature TT set based on the output electric power OP.

What is claimed is:

1. A charging system for a battery, the charging system comprising:
a battery that is chargeable using an external power source;
a heater for raising temperature of the battery; and
a control device for controlling driving of the heater, wherein
the control device
acquires an actual temperature of the battery and output electric power of the external power source,
sets a target temperature of the battery based on the output electric power, and
during charging of the battery using the external power source, drives the heater when the actual temperature is lower than the target temperature, and
the control device further
compares a present value of the output electric power with a previous value of the output electric power, during charging of the battery using the external power source, and
updates the target temperature based on the present value when the present value exceeds the previous value, and maintains the target temperature at a currently-standing value when the present value does not exceed the previous value.

2. The charging system according to claim 1, wherein the control device further
sets a value of the output electric power, at a time of starting charging of the battery using the external power source, as a reference value,
compares the present value with the reference value, and
when the present value exceeds the reference value, compares the present value with the previous value.

3. The charging system according to claim 1, wherein the control device further
records a greatest value of the output electric power after starting charging of the battery using the external power source,
compares the present value and the greatest value, and
when the present value exceeds the greatest value, compares the present value with the previous value.

4. A charging method for a battery, the charging method comprising:
a step of acquiring an actual temperature of a battery that is chargeable using an external power source, and output electric power of the external power source;
a step of setting a target temperature of the battery based on the output electric power;
a step of driving a heater for raising temperature of the battery, when the actual temperature is lower than the target temperature during charging of the battery using the external power source;
a step of comparing a present value of the output electric power with a previous value of the output electric power, during charging of the battery using the external power source; and
a step of updating the target temperature based on the present value when the present value exceeds the previous value, and maintaining the target temperature at a currently-standing value when the present value does not exceed the previous value.
